(19) United States
(12) Patent Application Publication
(10) Pub. No.: US 2003/0145876 A1
(43) Pub. Date: Aug. 7, 2003

(54) PRESSURE SENSING METHOD FOR DETERMINING GAS CLEAN END POINT

(76) Inventor: PEN CHEN SHIH, HSINCHU (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,465

(22) Filed: Jan. 22, 2003

(30) Foreign Application Priority Data
Feb. 5, 2002 (TW) 91101954

(51) Int. Cl. B08B 7/04

(52) U.S. Cl. 134/18; 134/22.1; 134/22.18

(57) ABSTRACT

A pressure sensing method of detect the end point in a gas cleanup reaction for removing a deposited coating on the interior wall of a low-pressure chemical vapor deposition furnace. The method includes passing a reactive gas into the low-pressure chemical vapor deposition furnace and monitoring a gas pressure inside the furnace. A control factor is varied so that gas pressure inside the furnace remains constant. The degree of variation of the control factor when thickness of the coating is reduced to an acceptable level is set as an end point value. The passage of reactive gas into the low-pressure chemical vapor deposition furnace is stopped as soon as the control factor reaches the end point value.

### CROSS REFERENCE TO RELATED APPLICATIONS

This application claims the priority benefit of Taiwan application Ser. No. 91101954, filed on Feb. 5, 2002.

### BACKGROUND OF INVENTION

1. Field of Invention

The present invention relates to a method of sensing gas clean end point. More particularly, the present invention relates to a pressure sensing method of determining gas clean end point.

2. Description of Related Art

In a conventional semiconductor manufacturing process, a low-pressure chemical vapor deposition is often conducted inside a furnace to form a deposition layer. The furnace is composed of an annealed quartz tube. After each low-pressure chemical vapor deposition, a layer reactant product will accumulate on the tube wall. When the deposits on the tube wall of the low-pressure chemical vapor deposition reach a certain thickness, the furnace tube is dismantled and the tube wall is cleanup by applying a corrosive chemical to remove the thick deposits. However, this method is not only labor intensive, but any accidental spillage of the corrosive chemicals may also harm the operator.

In recent years, various types of gas cleaning techniques have been developed.

These gas-cleaning techniques involve the passing of highly corrosive gases such as activated fluorine (F₂), nitrogen trifluoride (NF₃) and chlorine trifluoride (CIF₃) at a high temperature or at room temperature into the furnace. The corrosive gases react with the thick deposits on the tube wall and eventually remove the crust of the deposited material. Although this method avoids the dismantling of the furnace tube, which saves labor and machine down time, minimizes damages due to handling, and prevents accidental spillage of corrosive chemicals onto maintenance operator, the operator is prevented from assessing the cleanup status and determining the end point through visual inspection. Hence, the operator still has to perform a visual inspection upon the completion of the reaction and determine whether the end point has reached or the cleanup operation needs to be extended. Because there is no clear indication showing the end point, the maintenance operator can only make guesses, which may lead to over-etching. Over-etching has several drawbacks that includes a shortening of the working life of the quartz component; a roughening of the quartz surface leading to an increase in surface particles; and an increase in the dosage of corrosive gases leading to a higher cleaning cost.

To overcome the problems caused by over-etching, a thermocouple is installed inside the furnace tube to monitor the temperature rise due to the exothermic characteristics of the chemical reaction between a corrosive gas (such as chlorine trifluoride) and the deposited film (such as polysilicon). FIG. 1 is a graph showing a temperature versus time curve for a reaction between chlorine trifluoride and polysilicon in a conventional cleanup process. Using the temperature fluctuation in the thermocouple as an indicator, a cleanup end point for the furnace tube may be determined.

Nevertheless, the aforementioned method of using a thermocouple to determine cleanup end point has several drawbacks. If the polysilicon coating on the tube wall is uneven, the measurement of the temperature within the tube wall using a thermocouple and the temperature as an end point indicator may not be accurate. This is because the polysilicon close to the thermocouple may be completely removed but the residual polysilicon still clings to the tube wall further away from the thermocouple. Secondly, the temperature variation in each dry cleaning operation for each machine is different. Hence, it is almost impossible to set up a recipe to terminate the cleaning operation automatically. Finally, if for whatever reason, no thermocouple has been installed inside the furnace tube, this method of detection is not feasible.

Inside some plasma-enhanced chemical vapor deposition furnace, nitrogen trifluoride is used as a gas-cleaning agent. The product resulting from the gas cleaning operation generates a special spectrum when surrounded by plasma. Hence, the reaction end point may be determined through monitoring the output spectrum. However, most low-pressure chemical vapor reaction furnace does not have such expensive spectrum detector. At present, there is still no cost effective method or device for detecting the end point of a cleanup operation.

### SUMMARY OF INVENTION

Accordingly, one objective of the present invention is to provide a method that utilizes pressure to detect the end point in a gas cleanup and prevent any over-etching of the interior wall of a furnace. Consequently, there is no need to manually dismantle the furnace and remove the coating on the interior surface of the low-pressure chemical vapor deposition furnace, to perform a visual inspection of the furnace interior during cleanup or to install a spectrum end point detector.

To achieve these and other advantages and in accordance with the purpose of the invention, as embodied and broadly described herein, the invention provides a pressure sensing method of determining the end point in a gas cleanup reaction for removing a deposited coating on the interior wall of a low-pressure chemical vapor deposition furnace. The method includes passing a reactive gas into the low-pressure chemical vapor deposition furnace and monitoring the gas pressure inside the furnace. A control factor is varied so that the gas pressure inside the furnace remains constant. As soon as the chemically deposited coating on the furnace tube is removed to a certain extent, the extent of variation of the control factor is registered to serve as a reaction end point value.

This invention also provides a pressure sensing method of detecting the end point in a gas cleanup reaction for removing a deposited coating on the interior wall of a low-pressure chemical vapor deposition furnace. This method includes passing a reactive gas into the low-pressure chemical vapor deposition furnace and monitoring the gas pressure inside the furnace. A control factor is varied so that a constant gas pressure is maintained inside the furnace. As soon as the control factor reaches a reaction end point value, the passage of reactive gas into the low-pressure chemical vapor deposition furnace is stopped. Consequently, the furnace is thoroughly cleaned without dismantling the furnace manually or over-etching the furnace wall.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a graph showing the temperature versus time curve for a reaction between chlorine trifluoride and polysilicon in a conventional cleanup process;

FIG. 2 is a schematic view of a low-pressure chemical vapor deposition furnace and an associated pressure control system according to a first embodiment of this invention;

6 FIG. 3 is a graph showing the fluctuation of gas pressure with time inside a low-pressure chemical vapor deposition furnace according to this invention;

FIG. 4 is a graph showing the pressure curves comparing the effectiveness of gas cleanup end point detection between monitoring temperature using a conventional internal thermocouple and monitoring gas pressure according to this invention; and

FIG. 5 is a schematic view of a low-pressure chemical vapor deposition furnace and associated pressure control system according to a second embodiment of this invention.

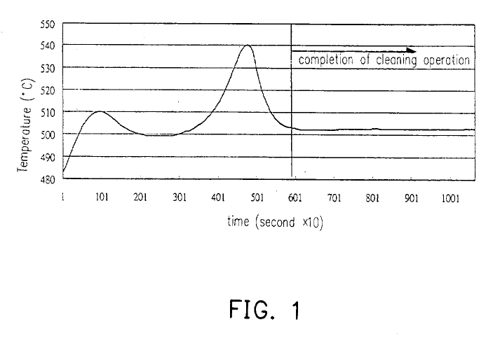

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

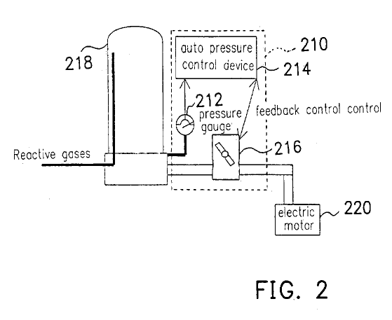

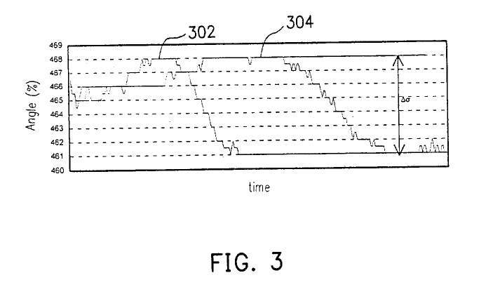

FIG. 2 is a schematic view of a low-pressure chemical vapor deposition furnace and an associated pressure control system according to the first embodiment of this invention. The pressure control system 210 as shown in FIG. 2 includes a pressure gauge 212, an auto pressure control device 214, and a damper 216 (may also use a butterfly valve or a piston valve). According to the pressure inside the low-pressure chemical vapor deposition furnace 218, the pressure control system 210 controls the amount of gas pumped out from the furnace 218 through an electric motor 220 so that a constant pressure is always maintained inside the furnace 218.

As the deposited coating (a polysilicon layer in this embodiment) on the interior sidewall of the low-pressure chemical vapor deposition furnace 218 reaches a desired thickness, a reactive gas (chlorine trifluoride in this embodiment) is passed into the furnace 218. The chlorine trifluoride reacts with the polysilicon coating inside the low-pressure chemical vapor deposition furnace 218 to rejuvenate the reaction chamber according to the following chemical formula:

4ClF_{3(g)}+3Si₍ₛ₎→3SiF_{4(g)}+2Cl_{2(g)}

Here, silicon tetrafluoride (SiF_{4(g)}) and chlorine (Cl_{2(g)}) are in gaseous state and hence can pumped out from the reaction chamber of the furnace 218 through the or 220. No manual cleanup operation is therefore required.

From the above chemical reaction formula, 4 moles of gaseous chlorine trifluoride (ClF₃) react with solid silicon at a constant temperature to form 5 moles of gaseous products (includes 3 moles of SiF_{4(g)}) and 2 moles of Cl_{2(g)}). Since gas pressure is directly proportional to gas mole ratio, the reaction between chlorine trifluoride and polysilicon will increase the interior pressure of the low-pressure chemical vapor deposition furnace 218. As the pressure inside the reaction chamber of the furnace 218 builds up, the pressure gauge 212 generates a pressure signal and the pressure signal is subsequently transferred to the auto pressure control device 210. According to this pressure signal, the auto pressure control device 210 sends back a feedback signal to change the opening angle of the damper 216 so that the amount of gas pumped out by the electric motor 220 is increased. Hence, a constant pressure is maintained inside the reaction chamber of the low-pressure chemical vapor deposition furnace 218.

Through experiments, the activation energy for reacting chlorine trifluoride with polysilicon is 0.39 eV while the activation energy for reacting chlorine trifluoride with quartz (SiO2) is 0.76 eV. When the polysilicon coating inside the low-pressure chemical vapor deposition furnace 218 is chemically etched by the chlorine trifluoride to a desired level (such as the complete removal of the polysilicon coating or scrap down to a desired thickness), some chlorine trifluoride may react with the quartz component. Since the reaction rate of chlorine trifluoride with quartz material is far lower than the reaction rate of chlorine trifluoride with polysilicon, the amount of gas that needs to be pumped out from the reaction chamber by the motor 220 will drop suddenly. The sudden drop of pressure in the pressure gauge 112 generates a pressure signal. The pressure signal is transmitted to the auto-pressure control 210. According to the pressure signal, the angle of the damper 216 is changed to reduce the amount of gas pumped out from reaction chamber of the low-pressure chemical vapor deposition furnace 218 so that a constant pressure is maintained.

FIG. 3 is a graph showing the fluctuation of gas pressure with time inside a low-pressure chemical vapor deposition furnace according to this invention. As shown in FIG. 3, when the thickness of the coating inside the low-pressure chemical vapor deposition furnace 218 (refer to FIG. 2) is 5 μm, the opening angle of the damper 216 (shown in FIG. 2) between the chlorine trifluoride and polysilicon during the chemical reaction is shown in curve 302. On the other hand, when the thickness of the coating inside the low-pressure chemical vapor deposition furnace 218 (refer to FIG. 2) is 8 μm, the opening angle of the damper 216 (shown in FIG. 2) between the chlorine trifluoride and polysilicon during the chemical reaction is shown in curve 304. From the curves 302 and 304, the auto pressure control device 214 (refer to FIG. 2) sends feedback control signals to the damper 216 (refer to FIG. 2) leading to the generation of an initial opening angle, a largest peak opening angle and the smallest opening angle of the damper 216. According to the difference Δσ between the initial, the largest and the smallest opening angle of the damper 216, the end point of the reaction can be defined. When the auto pressure control device 214 (refer to FIG. 2) senses the change in the opening angle of the damper 216 from an initial opening angle, coming to a peak opening angle, and then falling back to a smallest opening angle, the end point of the reaction is reached. At this point, the passage of gaseous chlorine trifluoride into the low-pressure chemical vapor deposition furnace 218 (refer to FIG. 2) is stopped to prevent over-etching.

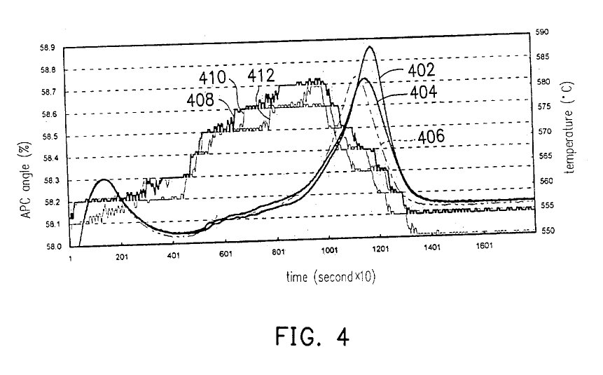

FIG. 4 is a graph showing the pressure curves for comparing the effectiveness of gas cleanup end point detection between monitoring temperature using a conventional internal thermocouple and monitoring gas pressure according to this invention. As shown in FIG. 4, curves 402, 404 and 406 represent the variation of temperature during chemical etching to cleanup three coatings of different thickness on the interior wall of a reaction chamber using a conventional thermocouple temperature sensing control system. The three curves 402, 404 and 406 have no common signs that show the closeness to the end point in the gas cleanup operation and temperature difference between the three curves near the end of the reaction ranges between 1˜5° C. Hence, the thermocouple temperature sensing method provides only a very inaccurate indication of the end point of the etching operation. On the other hand, pressure curves 408, 410 and 412 according to this invention provides a constant angle difference of 0.7 between the highest opening angle value and the lowest opening angle value. Therefore, the end point of the gas cleanup reaction can be accurately defined to be APC angle (the largest value) APC angle (the smallest angle)=time node having the set difference. In other words, this invention needs no other detecting devices to find the end point of a gas cleanup reaction and the end point may be further defined as a specification parameter so that the cleanup reaction may operate automatically.

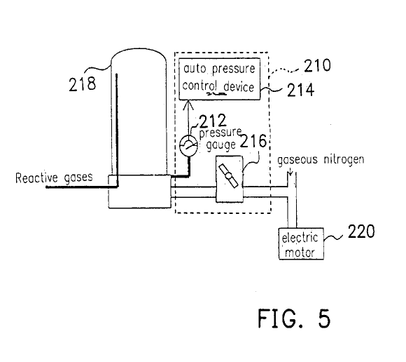

FIG. 5 is a schematic view of a low-pressure chemical vapor deposition furnace and an associated pressure control system according to the second embodiment of this invention. The pressure control system is very similar to the one shown in FIG. 2. Aside from pumping gases out from the low-pressure chemical vapor deposition furnace 218, the electric motor 220 in FIG. 5 also pumps out the externally added gaseous nitrogen (N₂)

In FIG. 5, the automatic pressure control device 214 sends feedback control signals to the damper 216 so that gases are exhausted at a fixed opening angle. Before the reactive gases are passed into the reaction chamber of the low-pressure chemical vapor deposition furnace 218, the pressure gauge 212 monitors a constant value inside the reaction chamber. The pressure gauge 212 issues a pressure signal corresponding to the measured pressure value to the auto pressure control device 214. According to the pressure signal, the auto pressure control device 214 controls the amount of gaseous nitrogen to be exhausted such that the sum of gases exhausted from the low-pressure chemical vapor deposition furnace 218 and the gaseous nitrogen through the electric motor 220 remain at a fixed value.

When the reactive gases are passed into the low-pressure chemical vapor deposition furnace 218, the pressure inside the reaction chamber suddenly increases due to the chemical reaction with the interior polysilicon coating. Ultimately, the volume of gases to be exhausted from the reaction chamber also increases. The pressure inside the reaction chamber measured by the pressure gauge 212 also increases triggering the transmission of a pressure increase signal to the auto pressure control device 214. According to the pressure signal, the auto pressure control device 214 reduces the exhaustion of gaseous nitrogen. Hence, the increase volume of gases exhausted from the furnace 218 and the decrease volume of gaseous nitrogen balances each other so that electric motor 220 still pumps out a fixed volume of gases.

When the passage of reactive gases into the low-pressure chemical vapor deposition furnace 218 has continued for some time, the thickness of the deposited coating on the interior wall of the furnace 218 is reduced by etching to an acceptable range (such as the entire deposited coating is removed or a desired thickness of the coating is removed). Hence, the pressure inside the furnace 218 is reduced and the volume of gases to be exhausted from the furnace 218 is reduced. At this stage, the pressure inside the reaction chamber measured by the pressure gauge 212 decreases triggering the transmission of a pressure reduction signal to the auto pressure control device 214. According to the pressure signal, the auto pressure control device 214 increases the exhaustion of gaseous nitrogen. Hence, the decrease volume of gases exhausted from the furnace 218 and the increase volume of gaseous nitrogen balances each other so that electric motor 220 still pumps out a fixed volume of gases.

The auto pressure control device 214 performs a feedback control of the amount of externally provided gaseous nitrogen by receiving a pressure signal submitted from the pressure gauge 212 leading to the generation of an initial nitrogen exhaust value, a largest peak nitrogen exhaust value, and a lowest nitrogen exhaust value. According to the difference Δσ between the initial, the largest, and the smallest values, the end point of the reaction can be defined. When the auto pressure control device 214 senses a change in the volume of the exhaust gaseous nitrogen from an initial value, coming to a peak value and then falling back to a smallest value, the end point of the reaction is reached. At this point, the passage of the reactive gases into the low-pressure chemical vapor deposition furnace 218 is stopped to prevent over-etching.

In conclusion, this invention provides at least the following advantages. Firstly, there is no need to manually dismantle the furnace so that time is saved and harm to operators caused by accidental spillage of corrosive substances is entirely prevented. Secondly, there is no need for visual inspection to determine etching end point. Since over-etching is prevented, some cleanup reactive gases are saved. Thirdly, there is no need to install expensive detectors to find the cleanup end point.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A pressure sensing method of determining an end point during a gas cleaning operation for removing a deposited coating on an interior wall of a low-pressure chemical vapor deposition furnace, the method comprising the steps of:
passing a reactive gas into the low-pressure chemical vapor deposition furnace;
monitoring gaseous pressure inside the low-pressure chemical vapor deposition furnace;
changing a control factor so that gaseous pressure inside the low-pressure chemical vapor deposition furnace remains constant; and
setting a degree of change of the control factor as a value reflecting the reaction end point when thickness of the deposited coating on the interior wall of the furnace is reduced to an acceptable range.

2. The method of claim 1, wherein the reactive gas is selected from a group consisting of fluorine, nitrogen trifluoride and chlorine trifluoride.

3. The method of claim 1, wherein a pressure gauge detects gas pressure inside the low-pressure chemical vapor deposition furnace and the pressure gauge submits a pressure signal to an auto pressure control device so that the auto pressure control device may continuously monitor the gas pressure inside the furnace, and the auto pressure control device is also capable of submitting a control signal to terminate the passage of reactive gas into the furnace.

4. The method of claim 1, wherein the step of linking any change in gas pressure inside the furnace to corresponding change in the control factor so that the furnace can maintain a constant internal pressure includes changing the volume of gas exhausted from the low-pressure chemical vapor deposition furnace.

5. The method of claim 4, wherein gases inside the low-pressure chemical vapor deposition furnace is exhausted through a pump connected to an electric motor.

6. The method of claim 4, wherein the step of controlling the volume of gas exhausted from the low-pressure chemical vapor deposition furnace includes using a device selected from a group consisting of a damper, a butterfly valve and a piston valve.

7. The method of claim 1, wherein the step of linking any change in gas pressure inside the furnace to corresponding change in the control factor so that the furnace can maintain a constant internal pressure includes changing the volume of an externally provided non-reactive gas in the exhaust so that the sum of the volume of gases exhausted from the furnace and the non-reactive gas remains constant.

8. The method of claim 7, wherein the pump driven by electric motor pumps gases from the low-pressure chemical vapor deposition furnace as well as the externally provided non-reactive gas.

9. A pressure sensing method of determining an end point during a gas cleaning operation for removing a deposited coating on anthe interior-wall of a low-pressure chemical vapor deposition furnace, the method comprising the steps of:
passing a reactive gas into the low-pressure chemical vapor deposition furnace;
monitoring gaseous pressure inside the low-pressure chemical vapor deposition furnace;
changing a control factor so that gaseous pressure inside the low-pressure chemical vapor deposition furnace remains constant; and
terminating the passage of reactive gas into the low-pressure chemical vapor deposition furnace when thickness of the deposited coating on the interior wall of the furnace is reduced to an acceptable range.

10. The method of claim 9, wherein the reactive gas is selected from a group consisting of fluorine, nitrogen trifluoride and chlorine trifluoride.

11. The method of claim 9, wherein a pressure gauge detects gas pressure inside the low-pressure chemical vapor deposition furnace and the pressure gauge submits a pressure signal to an auto pressure control device so that the auto pressure control device may continuously monitor the gas pressure inside the furnace, and the auto pressure control device is also capable of submitting a control signal to terminate the passage of reactive gas into the furnace.

12. The method of claim 9, wherein the step of linking any change in gas pressure inside the furnace to corresponding change in the control factor so that the furnace can maintain a constant internal pressure includes changing the volume of gas exhausted from the low-pressure chemical vapor deposition furnace.

13. The method of claim 12, wherein gases inside the low-pressure chemical vapor deposition furnace is exhausted through a pump connected to an electric motor.

14. The method of claim 12, wherein the step of controlling the volume of gas exhausted from the low-pressure chemical vapor deposition furnace includes using a device selected from a group consisting of a damper, a butterfly valve and a piston valve.

15. The method of claim 9, wherein the step of linking any change in gas pressure inside the furnace to corresponding change in the control factor so that the furnace can maintain a constant internal pressure includes changing the volume of an externally provided non-reactive gas in the exhaust so that the sum of the volume of gases exhausted from the furnace and the non-reactive gas remains constant.

16. The method of claim 15, wherein the pump driven by electric motor pumps gases from the low-pressure chemical vapor deposition furnace as well as the externally provided non-reactive gas.
